(19) United States
(12) Patent Application Publication
(10) Pub. No.: US 2005/0090268 A1
(43) Pub. Date: Apr. 28, 2005

(54) Base station for mobile terminal positioning system

(75) Inventors: Ryota Yamasaki, Kokubunji (JP); Atsushi Ogino, Kodaira (JP); Tsuyoshi Tamaki, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/875,822

(22) Filed: Jun. 25, 2004

(30) Foreign Application Priority Data
Oct. 23, 2003 (JP) 2003-362753

(51) Int. Cl. H04Q 7/20

(52) U.S. Cl. 455/456.5; 455/456.1

(57) ABSTRACT

Method and device for detecting the position of a base station in mobile terminal positioning system, which improves the success rate for detecting the position and improves the detection accuracy. The device is composed of a memory to record the received signals, a counter to record the time the signals were received, and a register to temporarily store the counter values; and also a position module interrupt signal sent to the memory during recording of a signal, and a data link interrupt signal issued during data link processing, and a position module information table for recording information relating to the memory, and a MAC information table for recording information relating to MAC processing. The counter value is stored in the register during issue of a position module interrupt, and the counter value is recorded in the position module information table. The counter value stored in the register is stored in the MAC information table during issue of a data link interrupt. A matching record RM is searched for by utilizing the base station MAC address, terminal MAC address and the signal type; and a record RL where the record RM matches the counter value is searched for in the position module information table. Signal data in the memory matching the buffer ID recorded in the record RL is handled as the position detection packet.

### CLAIM OF PRIORITY

The present application claims priority from Japanese application JP 2003-362753 filed on Oct. 23, 2003, the content of which is hereby incorporated by reference in its entirety.

### BACKGROUND OF THE INVENTION

1. Field of the Invention

The present invention relates to a wireless base station device comprising a position detection system, a position detection method, and position detection device for detecting the position of a terminal in a mobile communication system. The present invention relates in particular to a position detection method for finding the terminal coordinates of a terminal by trilateration utilizing the differential in signal propagation times between the terminal and multiple base stations.

2. Discussion of Background

The most widely used system in the related art for detecting the position of a terminal is GPS (Global Positioning System). GPS is accurate from approximately one meter to ten meters and has the advantage of being usable all over the world regardless of the region. However, this system has the disadvantage that since satellites are used to measure the position of the (mobile) terminal, the radio waves from the satellite are often blocked in areas including the inside of buildings and underground facilities, and tall buildings in cities where the system is often required.

This problem led to proposals of a number of position detection systems using mobile communication systems such as cellular telephones. A CDMA type digital mobile communication system in JP-A No. 181242/1995 discloses a method for acquiring the time differential of a PN code signal sent from four base stations and then calculating the terminal position coordinates. This method for finding the respective signal propagation times between multiple wireless base stations and each wireless terminal in this way and calculating the intersection (cross point) of the hyperbola to find the terminal coordinates is called the TDOA (Time Difference of Arrival) method. This TDOA method is widely utilized as a position detection method in mobile unit communication systems.

A position detection method other than the TDOA system is the CS-ID (cell station ID) for base stations. In this method disclosed in JP-A No. 156882/2000 the vicinity of the base station that the terminal is communicating with is set as terminal position information. The coverage range of the base station is the accuracy of the terminal position so the position accuracy is usually from about several dozen to several hundred meters.

These position detection systems of the related art are mainly configured on cellular telephone networks. Cellular telephone networks are currently the most widely spreading networks. Positions detection systems are also expected to spread widely.

On the other hand, the communication environment resulting from the IEEE802.11b and IEEE802.11a wireless LAN standards established by the IEEE (Institute of Electrical and Electronic Engineers USA) is spreading rapidly. A position detection system utilizing wireless LAN is revealed by Atsushi Ogino and five others in “Wireless LAN Unified Access Systems (1) Evaluation of Position Detection Systems”, 2003 General Conference collected lecture papers, IEICE, B-5-203, p. 662 (Non-patent Document 1). This system is characterized in that the wireless signals exchanged between terminal and base station are received by multiple base stations separate from the communicating base station, and the terminal position is determined based on the time each wireless signal was received. The statistical properties of the differential used to determine the terminal position depends on the RF propagation environment of the system. However, a system having a structure that renders greater cost effectiveness is preferred. See JP-A No. 181242/1995; JP-A No. 156882/2000; Atsushi Ogino, et. al., in “Wireless LAN Unified Access Systems (1) Evaluation of Position Detection Systems”, 2003 General Conference collected lecture papers, IEICE, B-5-203, p. 662 (Ogino et al.).

In Ogino et al., the signals exchanged between the terminal and base station, are received by other (multiple) measurement base stations and these signals stored in a signal recording area within the measurement base station device. Each measurement base station simultaneously records the time the signal was received, and the transmission (propagation) time differential of that signal is then calculated based on the difference in those signal receive times. The coordinates of the (mobile) terminal can then be calculated. Other signals besides the position detection signals, such as signals from communication of other terminals and control signals between base stations or between mobile terminals and base stations, are sent and received at this time. Therefore, when a signal other than a position detection signal is sent while a measurement base station is awaiting the receiving of a position detection signal to record, that signal is also recorded by multiple measurement base stations. Consequently, the signal for measurement, and other communication signals are stored in random order in the recording area of the measurement base station. So the position detection signal must be correctly selected from among these multiple signals in order to perform position detection correctly.

### SUMMARY OF THE INVENTION

It has been recognized that what is needed is a position measurement system in which the position detection signal is correctly selected from among multiple signals in order to perform position detection correctly. Broadly speaking, the present invention fills this need by providing a system and method for correctly selecting the position detection signal from among the multiple signals received by the measurement base stations. It should be appreciated that the present invention can be implemented in numerous ways, including as a process, an apparatus, a system, a device or a method. Inventive embodiments of the present invention are summarized below.

The measurement base station possesses two systems. One system is a receiving system for analyzing information contained in the received signal such as the MAC address and signal type. Another system is a recording system for recording and accumulating the signal data in the memory. The measurement base station further contains a labeling mechanism for matching the signal information processed in the receive system, with the signal data recorded in the recording system. The measurement base station acquires information on the position detection signal in advance, and compares it with signal information analyzed in the receiving system. If the signal information matches the previously acquired information then a position detection signal is judged to have been received. The signal information on the position detection signal processed by this receiving system must next be linked with signal data recorded in the recording system. Labeling is performed in advance on the signal information and signal data. Comparing the labels allows linking the signal information with the signal data. Accordingly, this procedure can select the position detection signal from among multiple received signals. The position detection signal data selected by the measurement base station and the receive time (time signal was received) are sent to the position calculation server. The position calculation server calculates the mobile terminal position coordinates based on the receive time and the signal data. The mobile terminal position coordinates are in this way correctly calculated.

In the mobile terminal communication system, the position detection system of the present invention links the position detection signal information with the signal data within the memory storage area, and correctly selects the specified desired signal from among the multiple signals. The probability rate for detecting the terminal coordinates of the position detection system is consequently improved, and the detection accuracy is improved.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a concept diagram showing the overall position detection system, in accordance with an embodiment of the present invention;

FIG. 2 is a flow chart showing the position detection process, in accordance with an embodiment of the present invention;

FIG. 3 is a block diagram showing the embodiment of the base station structure, in accordance with an embodiment of the present invention;

FIG. 4 is a diagram showing the structure of the memory device, in accordance with an embodiment of the present invention;

FIG. 5 is a diagram illustrating the signal information table, in accordance with an embodiment of the present invention;

FIG. 6 is a drawing comparing the position module information table and MAC information table, in accordance with an embodiment of the present invention;

FIG. 7 is a diagram illustrating use of the counter and register, in accordance with an embodiment of the present invention;

FIG. 8 is a flow chart of the processing, in accordance with an embodiment of the present invention; and

FIG. 9 is a block diagram showing the structure of the base station, in accordance with an embodiment of the present invention.

### DESCRIPTION OF THE PREFERRED EMBODIMENTS

An invention for ***** is disclosed. Numerous specific details are set forth in order to provide a thorough understanding of the present invention. It will be understood, however, to one skilled in the art, that the present invention may be practiced with other specific details.

### Embodiment (A)

### Base Station with Position Detection Module Added

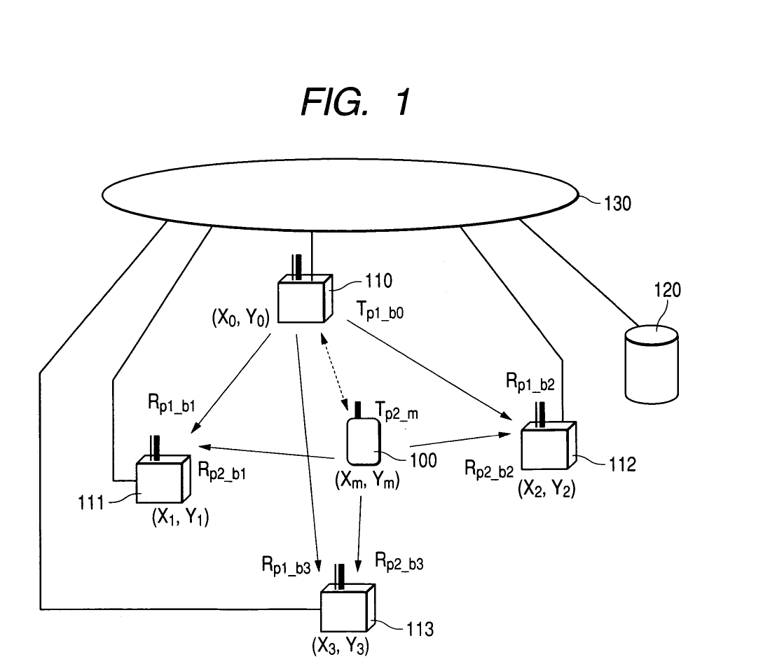

FIG. 1 is a concept diagram showing the overall position detection system, in accordance with an embodiment of the present invention. The system is made up of a terminal 100 whose position is detected, a base station 110 for wireless communication with the terminal 100, the measurement base stations 111, 112, 113 for making measurements for position detection, a position detection server 120 for making calculations for position detection, and a LAN (Local Area Network) 130 connected by cable to each base station. The coordinates of all base stations are already known having been measured in advance.

The signal processing flow for detecting the (mobile) terminal position is described next. The base stations on the wireless LAN are not originally in synchronization with each other so all the base stations must first be synchronized with each other. The base station 110 sends a synchronization signal to the terminal 100. The signal transmission time of base station 110 is set as Tp1_b0. The measurement base stations 111, 112, 113 are set to a receive state to intercept this signal. The signal receive times of each measurement station are set to Rp1_b1, Rp1_b2, Rp1_b3 at this time. These times are respectively values measured with the clocks possessed by each measurement base station.

Based on these times, the signal propagation time from the base station 110 to the measurement base stations 111, 112, 113 can be expressed as shown in Formula 1.
Tₚ₁_{_{—}}_{b1}=Rₚ₁_{_{—}}_{b1}−Tₚ₁_{_{—}}_{b0}−C_{—}diff_{b0}_{_{—}}_{b1}
Tₚ₁_{_{—}}_{b2}=Rₚ₁_{_{—}}_{b2}−Tₚ₁_{_{—}}_{b0}−C_{—}diff_{b0}_{_{—}}_{b2}
Tₚ₁_{_{—}}_{b3}=Rₚ₁_{_{—}}_{b3}−Tₚ₁_{_{—}}_{b0}−C_{—}diff_{b0}_{_{—}}_{b3} Formula 1

At this time, Tp1_b1 is the propagation time to the measurement base station 111, Tp1_b2 is the propagation time to the measurement base station 112, and Tp1_b3 is the propagation time to the measurement base station 113. Here, C_diffb0_b1 is the clock differential between the base stations 110 and 111. C_diffb0_b2 is the clock differential between the base stations 110 and 112. C_diffb0_b3 is the clock differential between the base stations 110 and 113. The value for Tbp1_b0 is not known since it cannot be measured.

The distance between base stations is equivalent to the value when the propagation time is converted into a distance and allows expressing Formula 2 as shown next.

$${D}_{b1} = \sqrt{( {X}_{1} - {X}_{0} ) \text{?} + {( {Y}_{1} - {Y}_{0} )}^{2}} = c \times T \text{?} \\ {D}_{b2} = \sqrt{{( {X}_{2} - {X}_{0} )}^{2} - {( {Y}_{2} - {Y}_{0} )}^{2} = c \times {T}_{2}} \\ {D}_{b3} = \sqrt{{( {X}_{3} \text{?} {X}_{0} )}^{2} - {( {Y}_{3} - {Y}_{0} )}^{2} = c \times {T}_{3}} \\ \text{?} \text{indicates text missing or illegible when filed} \qquad Formula 2$$

In this formula, Db1 is the distance between the base stations 110 and 111. Here, Db2 is the distance between the base stations 110 and 112. Db3 is the distance between the base stations 110 and 113. The coordinates of each base station are already known. Here, c expresses the speed of light.

The differential in the distance between base stations is expressed by Formula 3 based on the distance between base stations in Formula 2.

$${D}_{b3} - {D}_{b1} = c \times ( {R}_{p1\_b2} - {R}_{p1\_b1} - {C\_diff}_{b2} {\text{?}}_{b1} ) \\ {D}_{b3} - D \text{?} = c \times ( {R}_{p1\_b3} - {R}_{p1} \text{?} - {C\_diff}_{b3} {\text{?}}_{b1} ) \\ {D}_{b1} - {D}_{b2} - c \times ( {R}_{p1} {\text{?}}_{b3} - {R}_{p1} {\text{?}}_{b2} - {C\_diff}_{b3} {\text{?}}_{b2} ) \\ \text{?} \text{indicates text missing or illegible when filed} \qquad Formula 3$$

The clock differential between measurement base stations can be found with Formula 3. The measurement base stations can be synchronized with each other by compensating with the clock differential.

The measurement for detecting the terminal position is described next. The terminal 100 sends a response signal to the base station 110 for the synchronization signal. The signal transmit time of the terminal is set as Tp2_m. At this time, the response signal is intercepted the same as for synchronization, by the measurement base station receiving this response signal. The time the measurement base station 111 received the signal is set as Rp2_b1, the time the measurement base station 112 received the signal is Rp2_b2, the time the measurement base station 113 received the signal is Rp2_b3.

Formula 4 can be expressed as follows since distance between the terminal and the base stations is proportional to the propagation time.

$${D}_{m1} = \sqrt{\begin{matrix}{( {X}_{1} - X \text{?} )}^{2} + ( {Y}_{1} - {Y}_{m} ) - \\ c \times ( {R}_{p2} {\text{?}}_{b1} - T \text{?} )\end{matrix}} \\ {D}_{m2} = \sqrt{\begin{matrix}{( {X}_{2} - X \text{?} )}^{2} + ( {Y}_{2} - {Y}_{m} ) - \\ c \times ( {R}_{p2} {\text{?}}_{b2} - {T}_{p2} \text{?} )\end{matrix}} \\ {D}_{m3} = \sqrt{\begin{matrix}{( {X}_{3} - X \text{?} )}^{2} + ( {Y}_{3} - {Y}_{m} ) - \\ c \times ( {R}_{p2} {\text{?}}_{b3} - {T}_{p2} \text{?} )\end{matrix}} \\ \text{?} \text{indicates text missing or illegible when filed} \qquad Formula 4$$

Here, Dm1 is the distance between the terminal and the base station 111. Dm2 is the distance between the terminal and the base station 112. Dm3 is the distance between the terminal and the base station 113. The value for Tp2_m cannot be measured and is therefore unknown.

The differential in the distance between the base stations and the terminal is expressed as shown in Formula 5 based on Formula 4.

$${D}_{m2} - D \text{?} = c \times ( {R}_{p2} {\text{?}}_{b2} - {R}_{p2} {\text{?}}_{b1} ) \\ {D}_{m3} - D \text{?} = c \times ( {R}_{p2} {\text{?}}_{b3} - {R}_{p2\_b1} ) \\ {D}_{m3} - D \text{?} = c \times ( {R}_{p2} {\text{?}}_{b3} - {R}_{p3} {\text{?}}_{b2} ) \\ \text{?} \text{indicates text missing or illegible when filed} \qquad Formula 5$$

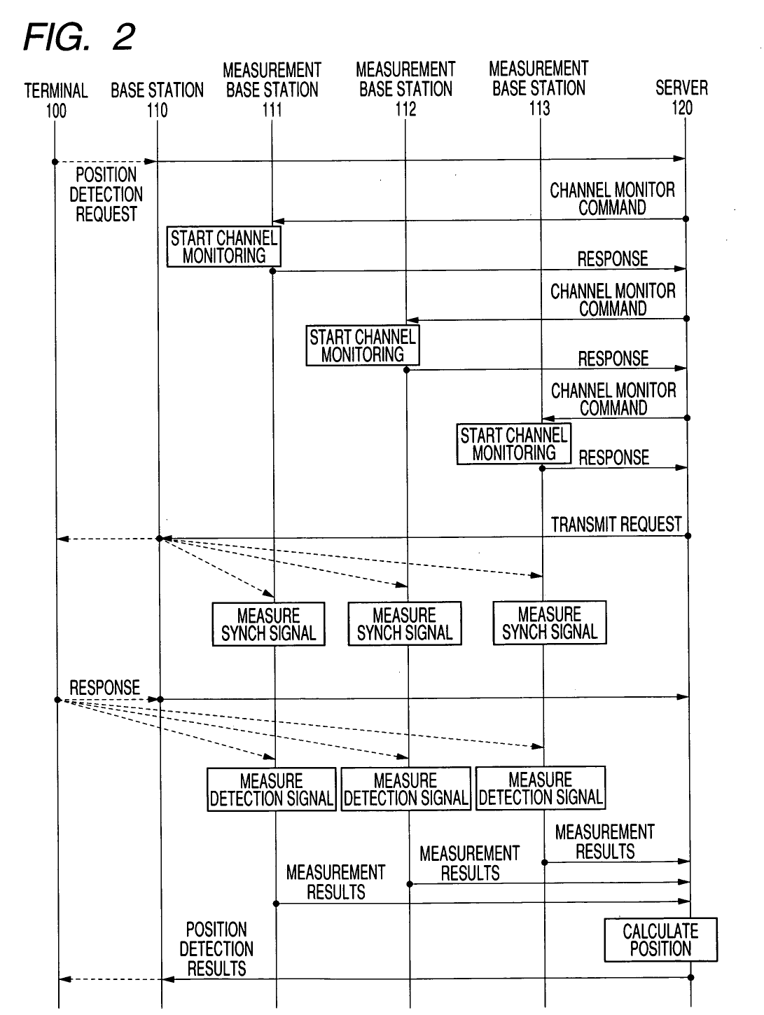

The terminal coordinates (Xm, Ym) can be found from Formula 5. FIG. 2 is a timing chart expressing the overall flow of the position detection processing using the above procedure, in accordance with an embodiment of the present invention. The vertical axis is the time axis. The solid lines with arrows express cable zones for communication and the broken lines with arrows express wireless zones for communication.

The terminal 100 sends a position detection request to the position detection server 120 while in communication with the base station 110. At that time, information on the frequency currently used by the terminal is appended to the position detection request message. The position detection server 120 sends an instruction to the measurement base stations 111, 112, 113 to monitor the frequency recorded in the frequency information. Each of the measurement base stations receives this monitor instruction and starts to monitor the frequencies used for position detection. The server 120 confirms that a reply to the monitoring instruction came back from all measurement base stations. When this confirmation is completed, the server 120 sends a synchronization signal to the terminal. The synchronization signal is conveyed to the wireless zone by way of the base station 110. At this time, each measurement base station in monitor status also receives the synchronization signal and measures the receive time of the signal. The terminal sends a reply signal to the server 120 as a response to the synchronization signal. The reply signal is sent to the server 120 by way of the base station 110 the same as the synchronization signal. The reply signal in the wireless zone is also received by each measurement base station, and each measurement base station measures the receive time of the reply signal.

Next, each measurement base station sends the synchronization signal data and its receive time, and the reply signal data and its receive time to the server. The server 120 that obtained the signal data and its receive time, calculates the clock differential of the measurement base stations based on the receive time of the synchronization signal and by compensating for that time, establishes a pseudo-synchronization. The terminal position coordinates are then calculated from that reply signal data and its receive time. These calculation results are sent back to the terminal that made the request, and its own position can then be verified. The measurement base station may also have the functions of a base station.

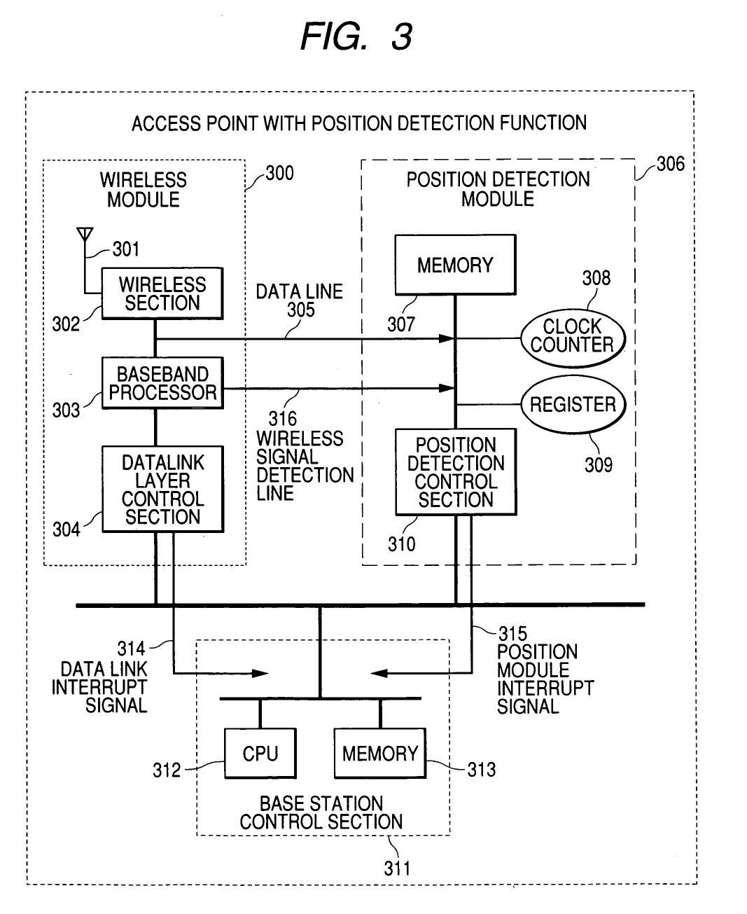

FIG. 3 is a block diagram showing the embodiment (A) of the present invention, in accordance with an embodiment of the present invention. The wireless base station is made up of a wireless module 300 for performing signal processing, and a base station control section 311 for controlling the entire base station. The position detection function is composed of module 306 as an add-on device to the base station equipment.

The wireless module 300 is composed of an antenna 301 to receive the wireless signals, a wireless section 302 to process the analog, high-frequency, a baseband processor section 303 to process signals in the baseband region, and a datalink layer control section 304 to process the datalink layer. A data line 305 is also provided for transferring IQ signal data from the signal bus between the wireless section 302 and the baseband processor section 303 directly to the board in the position detection module. The position detection module 306 contains a memory 307 for capturing signal data, a counter 308 for establishing the time the record processing of the received signal and the datalink control section processing ended, a register 309 capable of temporarily recording the counter value, and a control section 310 to manage these processing (tasks). When the receive signal is fed to the baseband processor section 303, the baseband processor section 303 outputs a wireless signal detection signal, and sends it to the position detection module 306 by way of wireless signal detection line 316. When the wireless signal detection signal is received, the position detection module records a fixed length (for example, the preamble length of 192 bits) portion and stops. The base station control section 311 controlling the entire wireless base station is composed of a CPU312 and a memory 313. The position detection control section 310 records the received signal in the memory and outputs an interrupt signal as the position module interrupt signal 315 to inform that the recording has ended. The datalink control section 304 outputs a datalink interrupt signal 312 as an interrupt signal to report that the datalink control processing is complete. The base station control section 311 receives the position module interrupt signal and, the datalink interrupt signal and runs processing for discriminating the position detection signal using software run on the CPU312 and memory 313. A summary for discriminating the position detection signal is described. The base station control section 311 compares the signal information analyzed within the wireless module 300 with information on the position detection signal, and searches for matching signal information. If a matching signal is found, then it is linked with signal data recorded in the position detection module. The measurement base station handles this linked (or corresponding) signal data as a position detection signal, and sends this signal data and its receive time to the position calculation server. The position calculation server performs position calculation based on that received signal data and that receive time, and calculates the terminal coordinates.

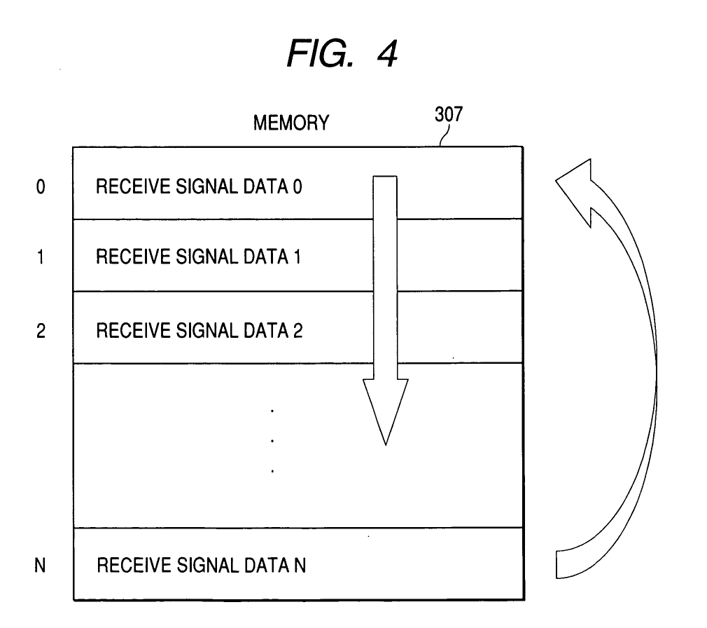

FIG. 4 shows the structure of the memory 307. The memory 307 is partitioned into multiple buffer zones, in accordance with an embodiment of the present invention. Each buffer zone stores data for one received signal. An ID is assigned to each buffer. The base station control section 311 identifies the buffer (by means of these IDs). These buffer IDs are utilized in sequence, and the received signal data are recorded in order of time. The base station control section 311 can directly search the buffer by the address on each buffer zone. There are a finite number of buffers. However when the available buffers have all been used, the method of reusing the buffers in the order of oldest data first can be utilized. In this case, the problem of using up all the buffers by, for example, using control signals without regard to the position detection process, can be avoided. The process can thereby be made more resistant to interference.

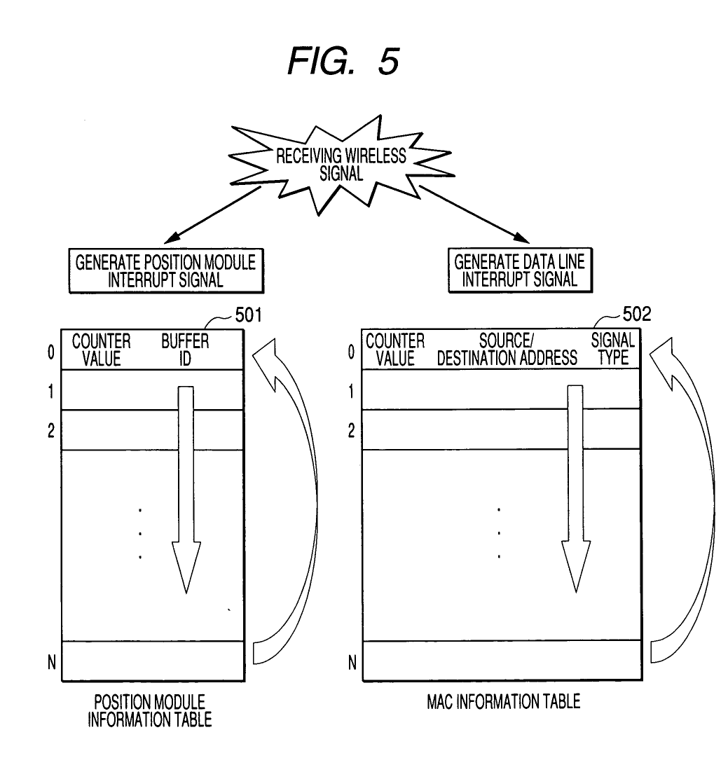

FIG. 5 is a diagram showing management of information relating to data recorded in the memory on the position detection module, in accordance with an embodiment of the present invention. The position module information table 501 is used to record information relating to received signal data recorded in the memory within the position detection module. The position module information table 501 is partitioned into records equal to the number of memory buffers. The counter value for the memory record completion time and the buffer ID are recorded in each record. When all records are used, the method of reusing from the oldest buffer, the same as for the memory buffer can be utilized. The MAC information table 502 is recorded with information during processing by the datalink control section 304. The MAC information table 502 is partitioned into records equal to the number of memory buffers, the same as the position module information table 501. Each record is recorded with the counter value, MAC address of the base station, MAC address of the terminal, and type of signal. When a position module interrupt has occurred, information is recorded on the records within the position module information table 501, and the ID number that is largest by 1 is set as the record area for recording the next signal information. When a datalink interrupt has occurred, the information is recorded in the record within the MAC information table 502.

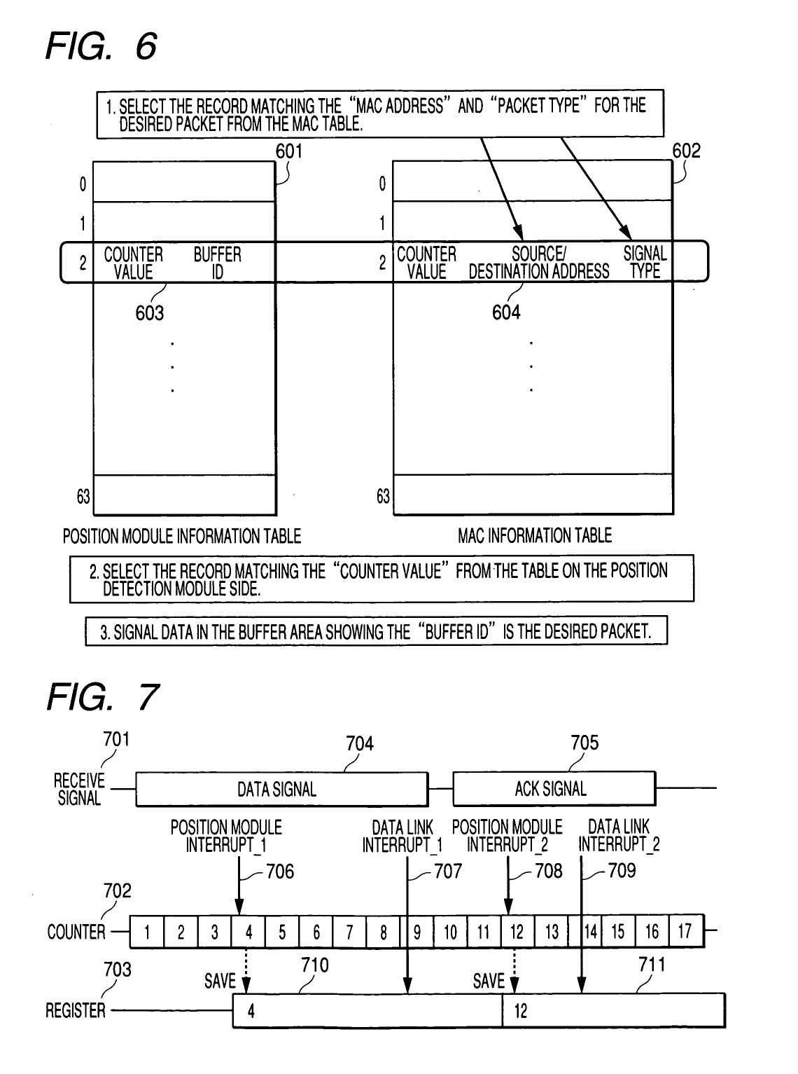

FIG. 6 is a drawing showing the procedure for selecting a record for recording the position detection signal linked to the records within the position module information table and MAC information table, in accordance with an embodiment of the present invention. First of all, a search is made of the MAC information table 602 based on the already known signal type, the terminal MAC address and the base station MAC address of the position detection signal. A record 604 is designated where the base station MAC address and terminal MAC address and the signal type are all a match. Next, the position module information table 601 is searched by using the counter value recorded in the designated record. A record 603 holding a counter value matching the designated counter value within the MAC information table 602 is designated from within the position information table 601. Receive signal data recorded in the memory buffer holding an ID number identical to the record ID linked to the designated record 604, is designated as the position detection signal data.

FIG. 7 shows a schematic diagram for a method for recording the receive time using the counter and the register, in accordance with an embodiment of the present invention. In the following description, a DATA signal is the signal type utilized in the synchronization signal sent from the base station to the measurement base station; and the ACK signal is the signal type utilized in the position detection signal sent from the terminal to the measurement base station. When the data signal 704 is sent and the preamble is detected, the baseband processing section outputs a wireless signal detection signal. When the position detection module receives the wireless signal detection signal, signal data of a fixed length is recorded and stopped. A preamble length of 192 bits, as established for example in the IEEE 802.11b standards, may be utilized as the length of the signal for recording. When recording the signal of the specified length is completed, the position detection module outputs a position module interrupt signal 706, and sends an instruction to store the counter 702 value into the register 703. The counter value stored in the register 703 is stored in the record 0 in the position module information table. In the datalink control section within the wireless module, however, a datalink interrupt signal_1707 is issued at the point in time that the MAC processing has ended.

The datalink layer control section issues a datalink interrupt_1 signal 707 after processing the datalink layer signal data, generally in order to delay the datalink interrupt_1 signal 707 more than the position module information signal 706. When the base station control section detects the datalink interrupt_1 signal 707, the counter value 710 stored in the register 703 is stored in the record 0 within the MAC information table, or information such as the base station MAC address, terminal MAC address and signal type analyzed from data processing results are stored. The time differential in which the position module interrupt signals and datalink interrupt signals occur is sufficiently short compared to the period that receive signals continuously arrive, so that counter values and signal information for the same signal can be acquired by the above procedure. The datalink layer control section issues a position module_2 signal 708 and datalink interrupt_2 signal 709 in the same way for the ACK signal 705 for data signal 704, and the counter value 702 is stored as value 711 in the register 703. The base station control section can in this way record information in the record of the MAC information table and position module information table when one signal is received. However, situations also occur where datalink processing was not performed due to reasons such as a low signal level. The register value is rewritten at the point in time that the next received signal is recorded and a position module interrupt signal occurs. When the counter values recorded in the position module information table and MAC information table are a match, it can therefore be judged that information from the same packet was recorded.

When signal information for signals recorded in the position detection module cannot be specified unless the signal is demodulated, using the position information module and MAC information table counter values serves to link these values so that the signal recorded in the position module can then be selected. The position detection signal can also be selected by using the signal type information to select the signal. A signal can also be selected for a terminal that issued a position detection request, by utilizing the MAC address of the base station and MAC address of the terminal sending and receiving the signal and, the position detection request from the terminal can be correctly processed.

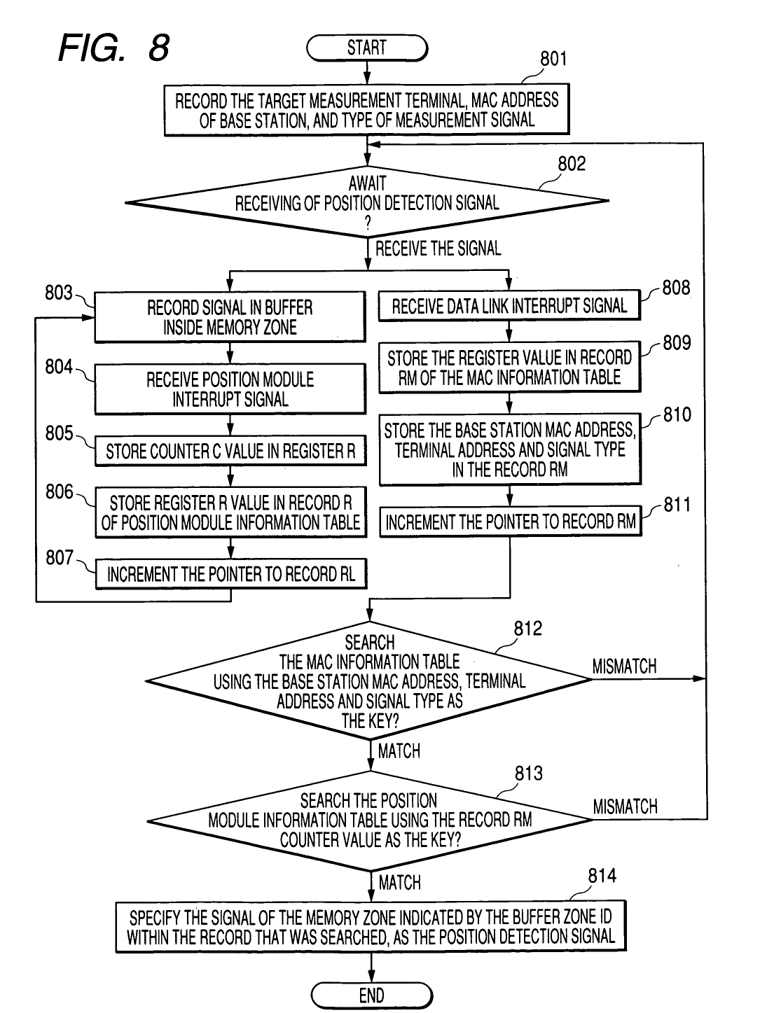

FIG. 8 shows the overall flow of the process for selecting the above described position detection signal, in accordance with an embodiment of the present invention. The selection process is described next.

In step 801, information relating to the position detection signal coming from the server is recorded. This recorded information is the base station MAC address, the terminal MAC address and the signal type. The position detection signal is next awaited in step 802. When this signal is received, the respective processing for the position detection module and wireless module then start. In step 803, the signal is recorded in the memory area of the position detection module. Next, in step 804, the position detection control section issues a position module interrupt signal after the recording of the signal has ended. The base station control section receives the position module interrupt signal and records the counter value in the register in step 805. Next, in step 806, the base station control section stores the counter value stored in the register, and the buffer ID for the zone where the signal is recorded, into the record RL within the position module information table 501. In step 807, an area is obtained for storing the next received signal information.

In step 808, a datalink interrupt signal is issued in the wireless module. The base station control section receives the datalink interrupt signal that was issued and in step 809 stores the register value in record RM within the MAC information table. Next, the base control section in step 810 stores the base station MAC address, terminal MAC address and signal type in the record RM. In step 811, an area is secured for storing the next signal information.

Processing to link the information in the position module information table and information in the MAC information table is performed next. In step 812, a search is made in the MAC information table for records matching the base station MAC address, terminal MAC address and signal type of the position detection signal. If there is no matching record, then the process returns to step 802 to await a signal. If there is a matching record, then the processing next designates a corresponding area in the memory. In step 813, the record RM counter value in the MAC information table is compared with the record RL counter value within the position module information table. If there is no record in the position module information table holding the same counter value, then the signal selection was a failure, and the processing returns to step 802. However, if there is a record in the position module information table holding the same counter value, then the signal information in the position module information table is linked with the signal in the wireless base station. In step 814, the memory zone indicated by the buffer ID recorded in record RL within the position module information table is determined to be the memory zone where the position detection signal is recorded.

After the process described above for measuring the position detection signal, the counter value showing the signal data for the memory zone selected by the measurement base station and that signal receive time are sent to the position detection server. The position detection server calculates the differential in receive timing for each base measurement station by utilizing the counter value and signal data. Position detection calculation is then made based on the receive timing and the terminal coordinates can at last then be found. The above method allows selecting a signal to use for position detection, from among the multiple signals recorded in the memory of the measurement base station, and then correctly performing the position detection process.

### Embodiment (B)

### Base Station with Position Detection Function

An embodiment with the wireless bases station already incorporating a function for position detection is described next.

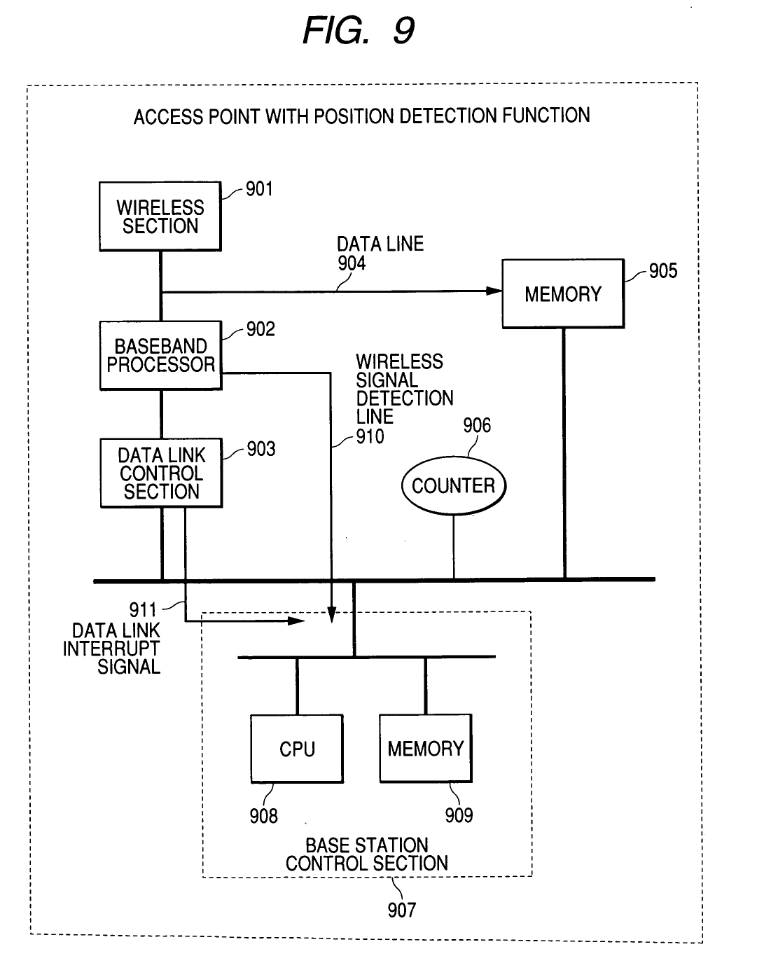

FIG. 9 shows an overall concept view of the wireless base station containing a signal recording device for position detection, in accordance with an embodiment of the present invention. The wireless base station is made up of a baseband processor section 902, a datalink control section 903, and a base station control section 907 for controlling the overall process. The base station control section 907 is composed of a CPU 908 and a memory 909. The base station further contains a memory 905 for recording signals for position detection, and a counter 906 for recording the receive timing of the signal. The baseband processor notifies the base station control section of the wireless signal detection signal 910 at the point in time that the signal was received and the receive operation commenced. The datalink control section 903 sends a datalink interrupt signal 911 to notify the base station control section 907 at the point in time that the datalink processing ends.

The procedure for capturing the position detection signal is described next. At the point in time that the measurement base station receives the signal and notifies the base station control section of the wireless signal detection signal, the base station control section records a fixed length of signal data into the memory, and stops. The base station control section links a counter value to the recorded signal data and the datalink information. The base station control section also compares the signal type and MAC address analyzed in the datalink control section with the already acquired position detection signal information. If these are a match, then the signal data holding a counter value identical to the counter value linked to the signal information is designated as the position detection signal.

1. A measurement base station device in a mobile terminal positioning system configured to detect a position of a wireless terminal using a differential in propagation times for a measurement signal calculated from receive timing of measurement signals received on multiple measurement base stations, the measurement base station device comprising:
a wireless module;
a position detection module;
a base station control section;
wherein the wireless module is configured to output a received signal to the position detection module, analyze an address of the received signal, and when analysis of that address is completed, output an address analysis signal to the base station control section to report address analysis results;
wherein the position detection module includes a first memory to record the received signal input from the wireless module, and a counter to measure a recorded time the received signal is recorded in the first memory, and a register to store a counter value for the recorded time, the position detection module being configured to output a recording notification signal to the base station control section;
wherein the base station control section is configured to store address information on the measurement signal, and when the recording notification signal is inputted, the based station control section stores the stored counter value in the register, and when the address analysis signal is inputted, the base station control section records the address analysis results and counter value stored in the register and determines whether the address analyzed signal is the measurement signal based on a comparison of the address analysis results and the measurement signal address information, and when the measurement signal is determined to be that address analyzed signal, the base station control section loads a receive signal from the first memory, the receive signal corresponding to a counter value identical to the counter value matching the address analyzed signal as the measurement signal.

2. The measurement base station device of claim 1, wherein the wireless module includes
a wireless section to convert the received wireless signals into baseband signals; and
a baseband section to accept the input of baseband signals and detect the receiving of the signals, and output the baseband signals to the position detection modules as received signals, and output signal detection notification signal to the position detection module to report detection of the signal;
wherein the position detection module includes a position detection control section to control the first memory, and after the position detection module replies to the input of the position detection notification signal and records a baseband signal with a fixed length in the first memory, the position detection control section stops the recording, outputs instructions, and records into the first memory counter values of the counter according to recording of the baseband signal.

3. The measurement base station device of claim 2, wherein
the first memory includes multiple buffer regions, the receive signals being configured to be recorded in respectively different buffer regions, and
when the recording notification signal has been input, the base station control section stores the buffer region information showing the buffer region where the received signal is recorded, along with the counter value, and when loading the received signal from the first memory, loads the buffer region showing the buffer region information corresponding to the counter value.

4. The measurement base station device of claim 3, wherein
the base station control section includes a second memory and a processing section, the second memory being configured to record address information for the measurement signals and to record an address information table and to record a record signal table with information on signals recorded in the memory; and
the processor section is configured to record onto the recording signal table the counter values recorded on the register and a buffer ID on the first memory, the counter values and the buffer ID corresponding to the input of a recording notification signal from the position detection control section; and
the processor section further records address information on address analyzed signals and counter values recorded in the register, onto the address information table, in response to input of address analysis signals from the wireless module; and
when the stored address information matches the measurement signal address information, the processor section searches the record signal table for a counter value identical to the counter values recorded in the address information table; and
when this search is successful, the processor section decides that the signal stored in the buffer ID corresponding to that counter value is the measurement signal.

5. The measurement base station device of claim 1, wherein
the address information for the measurement signal includes a wireless terminal address, a base station address and a signal type of the measurement signal; and
the address analysis determines a source address, a destination address and a signal type of the received signal.

6. A measurement base station device of claim 5, wherein
the address information for the measurement signal further includes a signal classification of measurement signals; and
the address analysis further decides a signal type of the received signal.

7. The measurement base station device of claim 1, wherein when the address analyzed signal determined to be the measurement signal is loaded from the first memory, information on this loaded signal is sent to a position calculation server.

8. The measurement base station device of claim 7, wherein a counter value corresponding to the loaded signal is sent along with the received signal information.

9. A method of measurement signal discrimination for a measurement base station device of a terminal position detection system configured to detect a position of a wireless terminal using a differential in propagation times for a measurement signal calculated from receive timing of measurement signals received on multiple measurement base stations, the terminal position detection system including a wireless terminal, a base station for wireless communication with the wireless terminal, multiple measurement base stations for receiving the measurement signals sent and received between the wireless terminal and the base station, and a position measurement server connected by way of a network with the base station and multiple measurement base stations, the method comprising:
receiving and storing the measurement signal address information from the position measurement server by way of the network;
assigning an identifier for identifying the address information;
by way of a wireless module, receiving a received signal into a wireless module, outputting the received signal to the position detection module, analyzing an address of the received signal, and when analysis of that address is completed, outputing an address analyzed signal to the base station control section to report address analysis results;
by way of a position detection module, recording the received signal input from the wireless module into a first memory, identifying the recorded signal, assigning an identifier as a link to the address information, outputing a recording notification signal to the base station control section to report storing of the received signal; and
by way of the base station control section, when a recording notification signal is input, identifying whether the address analyzed signal is the measurement signal based on a comparison of the address analysis results and the measurement signal address information, and when determined that the address analysis signal is the position detection signal, loading an identifier assigned to the address analysis signal and a received signal with a same identifier from the first memory as the measurement signal.

10. The method of claim 9, further comprising:
by way of the wireless module, converting the received signal into a baseband signal, outputing the baseband signal to the position detection module as the received signal;
detecting the receiving of the baseband signal that was input;
outputing a signal detection notification signal to the position detection module to report detection of the baseband signal; and
by way of the position detection module, instructing recording of the baseband signal in the first memory in response to input of the position detection notification signal, and recording a counter value of a counter in response to recording of the baseband signal into the first memory.

11. The method of claim 10, further comprising:
by way of the first memory, and recording received signals in respectively different buffer regions; and
by way of the base station control section, storing buffer region information showing which buffer region each received signal is recorded along with each counter value, when the recording notification signal was input and when the received signal was loaded from the first memory, loading buffer region information corresponding to each counter value from each buffer region.

12. The method of claim 11, further comprising by way of the base station control section:
recording address information for reported measurement signals, an address information table, and a record signal table with information on signals recorded in the memory;
recording on the recording signal table, the counter values recorded on the register and the buffer ID on the first memory storing signals reported from the position detection module, the counter values and buffer ID corresponding to the input of a recording notification signal from the position detection control section;
recording address information on address analyzed signals and counter values recorded in the register, onto the address information table, in response to input of address analysis signals from the wireless module;
when the stored address information matches the measurement signal address information, searching the record signal table for a counter value identical to the counter values recorded in the address information table; and
when this search is successful, deciding that the signal stored in the buffer ID corresponding to that counter value is the measurement signal.

13. The method of claim 9, wherein the address information for the measurement signal contains a wireless terminal address and a base station address, and wherein the step of analyzing the address includes determining a source address and a destination address of the received signal.

14. The method of claim 13, wherein the address information for the measurement signal contains a signal classification of measurement signals, and the step of analyzing the address further includes deciding the signal type of the received signal.

15. The method of claim 9, further comprising:
determining the measurement signal;
loading the measurement signal from the first memory; and
sending information on this loaded measurement signal to the position calculation server as the received signal information.

16. The method of claim 15, further comprising sending a counter value corresponding to the loaded signal along with the received signal information.
